(19) United States
(12) Patent Application Publication
(10) Pub. No.: US 2015/0017052 A1
(43) Pub. Date: Jan. 15, 2015

(54) Method for Joining Metal Components

(71) Applicant: Robert Bosch GmbH, Stuttgart (DE)

(72) Inventor: Mario Matic, Ulm (DE)

(21) Appl. No.: 14/369,438

(22) PCT Filed: Nov. 15, 2012
(86) PCT No.: PCT/EP2012/072698

§ 371 Date: Jun. 27, 2014

(30) Foreign Application Priority Data
Dec. 27, 2011 (DE) 10 2011 089 965.0

(51) Int. Cl. B23K 31/02; C22C 33/02; C22C 38/14; B23K 37/00; C23C 8/26; B22F 7/04

(52) U.S. Cl. CPC B23K 31/02; C23C 8/26; B22F 7/04; C22C 38/14; B23K 37/00; C22C 33/02
USPC 419/8; 228/262.1; 148/238; 420/126

(57) ABSTRACT

A method for joining metal components by welding includes welding a first component to a second component. At least one of the components is a nitrogen-containing component, and titanium is added to at least one of the components before the welding step.

The invention relates to a method for joining metal components, in particular steel components, by welding, wherein a first component is welded to a second component, at least one of the components being a nitrogen-containing component. In this case, nitrogen-containing components are understood to mean metal or steel components containing at least a non-zero or even significant proportion of nitrogen. On the one hand, the nitrogen can be dissolved in the alloy, and on the other hand it can also be present on the surface in a nitriding layer.

Methods for joining metal components, in particular steel components, by welding are widely known. When joining nitrogen-containing components, the problem whereby the nitrogen-containing material is melted on account of the high temperatures during welding arises more often, however. This leads to outgassing of the nitrogen present in the material or present in the alloy and/or in the nitriding layer. This outgassing leads to the formation of pores in the weld seam, as a result of which the cross section of the weld seam is weakened. As a consequence, this limits the fields of use for nitrogen-containing materials or materials which have been treated with nitrogen, since the strength of the weld seams cannot be reliably ensured.

In order to counter this problem, it is suggested in the prior art, for example, to remove the nitriding layer at the weld joint of the components before welding, so that outgassing of the nitrogen cannot occur. In the case of high volumes and consequently a large number of units, removal of the nitriding layer by grinding is, however, associated with great complexity and therefore also with high costs, and therefore this procedure should be avoided where possible.

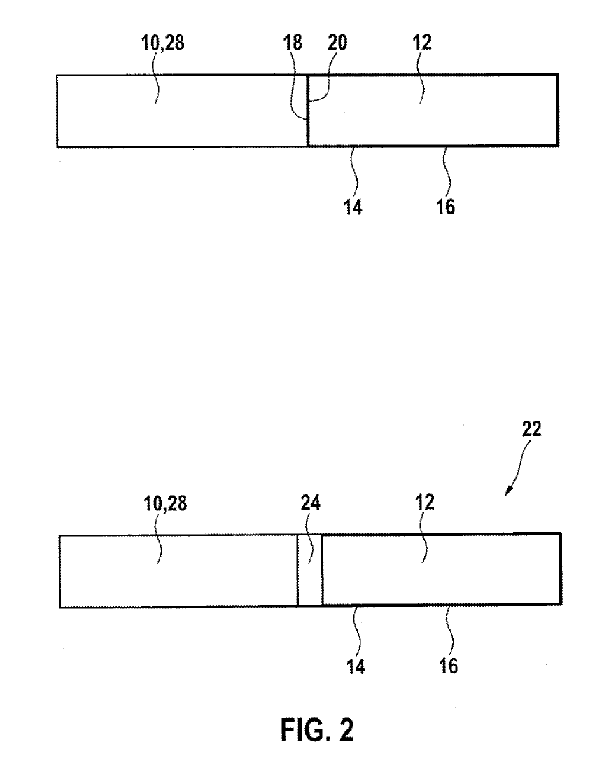

In their paper entitled “Laser Beam Welding of Nitride Steel Components” (published in Physics Procedia 12 (2011) 40 to 45), Gu et al. disclose a method for laser beam welding which addresses the problem of the nitrogen outgassing from the nitriding layer during welding. During welding, here a welding wire having a specific titanium content is supplied. The experimental investigations of Gu showed that there is an improvement in the welding operation in terms of the gas bubble formation on account of the outgassing of nitrogen (see in this respect FIG. 2 on the right in the publication by Gu). The improvement in the weld seam quality was achieved here by virtue of the fact that parts of the outgassing nitrogen bond with the titanium present in the welding wire in the molten mass. In the process, the nitrogen forms a compound with titanium in the form of titanium nitride. This reaction takes place at relatively high temperatures.

Upon closer examination of the weld seam, however, it was evident that in particular the weld root, i.e. the base of the weld seam, still contained a considerable number of gas bubbles.

The invention is therefore based on the object of providing a method for joining nitrogen-containing metal components, in particular steel components, by welding, in which case it should be possible for the method to be carried out easily and reliably, and in which case, even given deep weld seams, the formation of pores by outgassing nitrogen is to be avoided preferably over the entire cross section of the weld seam.

This object is achieved by a method having the features of claim 1. Accordingly, it is provided that titanium is added to at least one of the components before the welding step. In contrast to the prior art, titanium is added here before the welding process, whereas, in the prior art, a welding wire is supplied during welding. As a result, the welding process itself is simplified according to the invention, because titanium does not have to be added during the welding. Furthermore, there are considerably more degrees of freedom for the addition of titanium to the component to be welded, if the addition, as proposed according to the invention, is made before welding. The titanium which is added before the welding step then bonds the nitrogen outgassing from the nitrogen-containing component during the welding and prevents the formation of bubbles or pores by the nitrogen in the weld seam. Consequently, it is possible to prevent weakening of the weld seam. The titanium can be added to at least one component by any method in which the chemical composition of the component can be suitably, in particular freely or virtually freely, set. An appropriate titanium content can therefore already be added to the at least one component, for example also in the course of steel production. The method proves to be advantageous in particular for welding nitrogen-containing components, that is to say nitrogen-alloyed components or components provided with a nitriding layer. It is therefore also possible to avoid the formation of pores in the weld seam without the complicated supply of filler materials during welding, as is known from the prior art.

An advantageous configuration of the method is achieved by virtue of the fact that titanium is admixed to at least one component before the welding step. The admixture can be made here in the course of steel production or in the course of component production or post-machining. In this respect, a homogeneous admixture of the titanium into the entire component is conceivable, in which case the entire component then has the same titanium content. Furthermore, it is also conceivable, however, to admix titanium in such a manner that the component has a heterogeneous profile of the titanium content which is matched to the shape of the weld seam in a manner optimized for the application. The admixture of the titanium before the welding step is therefore advantageous since a titanium content which is sufficient for bonding the outgassing nitrogen is present over the entire component geometry. Consequently, it is possible to avoid the disadvantages of the prior art, specifically the formation of gas bubbles in the root of the weld seam.

According to a further advantageous configuration of the invention, titanium is applied to a weld joint of the at least one component before the welding step. For this purpose, by way of example, the titanium can be melted and applied to the weld joint. It is also possible, however, to apply a titanium-containing substance, in particular also without melting, to the weld joint. Furthermore, it is possible to apply titanium in atom form, for example by way of sputtering, to the weld joint. This would make it possible for the titanium content to be set in an extremely precise manner. The application of titanium to the weld joint before the welding step likewise proves to be advantageous over the prior art since, here too, it is possible to avoid gas bubble formation in the weld base.

Furthermore, it is advantageous if titanium is added to at least one of the components in the form of pure titanium and/or in the form of titanium-containing compounds and/or in the form of titanium-containing alloys. This can depend in particular on the way in which the titanium is introduced into the components. If, for example, titanium is added in the course of steel production, it is conceivable to add titanium in the form of pure titanium. When the titanium is applied to the weld joint, it is also possible, however, to add titanium in the form of titanium-containing compounds and/or in the form of titanium-containing alloys.

A particularly advantageous configuration of the method is achieved by virtue of the fact that at least one of the components is produced by a powder metallurgy production process. The chemical composition of the components to be produced can be set very precisely by means of powder metallurgy processes. Therefore, depending on the application, a content of titanium which is optimized for the application can be admixed in the component in a powder metallurgy production process. The powder metallurgy process used is advantageously the powder injection molding process called metal injection molding (MIM), or else the process variant 2C-MIM. Together with ceramic injection molding (CIM), metal injection molding (MIM) belongs to the powder injection molding processes (PIM). In the case of these powder injection molding processes, a powder with sintering properties is mixed with a binder, for example in the form of polyolefin wax mixtures. What is termed a green body is then produced in the course of an injection molding process. Heating results in the binder being melted out of the green body, as a result of which what is termed the brown body, a porous molded part, is formed. Finally, the brown bodies are compacted by thermal heating in what is termed a sintering process, with the ultimate material properties of the components being set.

According to a further advantageous configuration of the invention, at least one of the components is subjected to a nitriding process before the welding step. In this respect, it can be provided that a nitrogen-alloyed component is also subjected to a nitriding process before the welding step, with a nitriding layer then being applied to the component surface. Furthermore, it is also possible to subject a component to which titanium has already been added to a nitriding process. In this respect, a titanium-containing component can additionally be provided with a nitriding layer on its component surface. It is conceivable to provide the component with a nitriding layer by known processes, for example what is termed carbonitriding or nitrocarburizing. Both in carbonitriding and in nitrocarburizing, carbon in addition to nitrogen is enriched in the marginal layer of workpieces.

It is advantageous that, after the titanium addition step, at least one of the components has at least in certain regions a titanium content in the range of approximately 0.2% by weight to approximately 10% by weight, preferably in the range of approximately 0.5% by weight to approximately 5% by weight and further preferably in the range of approximately 0.5% by weight to approximately 1.5% by weight. This order of magnitude has proved to be particularly advantageous since, given this titanium content, the components have a sufficient titanium content for welding with nitrogen-containing components, without the function of the component moreover being disadvantageously limited. In this case, in certain regions means that the at least one component has at least one region in the entire component volume which has the corresponding titanium content with respect to the volume of the respective region. Thus, it can be provided, for example, that a region of this type is provided according to the invention with a specific titanium content in the vicinity of the component surface, for example at the weld joint.

Furthermore, it is advantageous if titanium is added to at least one of the components before the welding step in such a manner that, proceeding from a component surface, a titanium content of approximately 0.2% by weight to approximately 5% by weight, preferably of approximately 0.5% by weight to approximately 1.5% by weight, is formed in a depth range of approximately 0 mm to approximately 20 mm, preferably of approximately 0 mm to approximately 12 mm. Consequently, it can be ensured that, through the presence of a specific titanium content at the component surface, the nitrogen outgassing from the components or from the nitriding layer can be bound and bonds with the titanium to form titanium nitride. Such a titanium content dependent on the distance from the component surface is also therefore advantageous since titanium is required only down to a specific depth of the component for most welding methods in order to improve the suitability for welding and in order to bond the outgassing nitrogen. An optimized local adaptation of the titanium content of this type in the component therefore makes it possible to save costs, since a lower quantity of titanium is required. It is conceivable to adapt the titanium content to the geometry of the components and/or to the geometry of the weld seam.

Provision can also be made to provide any desired concentration gradient of the titanium proceeding from the component surface.

It is preferable that the at least one nitrogen-containing component is a nitrogen-alloyed and/or nitrided component. Components of this type have a relatively high nitrogen content at the component surface. The problem of the outgassing nitrogen therefore arises increasingly in the case of such nitrogen-alloyed and/or nitrided components; this leads to the formation of pores in the weld seam, as a result of which the cross section of the weld seam is weakened.

It is advantageous that nitrogen outgassing during the welding process is bound at least partially in the form of titanium nitride. In this way, it is possible to reliably avoid the formation of pores in the weld seam, since the nitrogen outgassing from the nitriding layer or from the nitrogen-alloyed component bonds with the titanium which is added to at least one of the components before the welding step to form titanium nitride.

A component as claimed in patent claim 11 is indicated as a further way of achieving the object of the present invention. Accordingly, it is provided that the component has at least in certain regions a titanium content in the range of approximately 0.2% by weight to approximately 10% by weight, preferably in the range of approximately 0.5% by weight to approximately 5% by weight and further preferably in the range of approximately 0.5% by weight to approximately 1.5% by weight. In this case, in certain regions means that the at least one component has at least one region in the entire component volume which has the corresponding titanium content with respect to the volume of the respective region. Thus, it can be provided, for example, that a region of this type is provided according to the invention with a specific titanium content in the vicinity of the component surface, for example at the weld joint.

It is particularly preferable here if the component has, proceeding from a component surface, a titanium content of approximately 0.2% by weight to approximately 5% by weight, preferably of approximately 0.5% by weight to approximately 1.5% by weight, in a depth range of approximately 0 mm to approximately 20 mm, preferably of approximately 0 mm to approximately 12 mm. In this respect, it is not absolutely necessary for the component to have such a titanium content at all surface regions of the component. It can also be provided that the component has such a titanium content only at the weld joint.

Furthermore, it is advantageous if the component has the titanium content in the range of approximately 0.2% by weight to approximately 10% by weight, preferably in the range of approximately 0.5% by weight to approximately 5% by weight and further preferably in the range of approximately 0.5% by weight to approximately 1.5% by weight homogeneously throughout its volume.

Further details and advantageous configurations of the invention can be gathered from the following description, on the basis of which the invention illustrated in the figures is described and explained in more detail. Corresponding elements are denoted here by corresponding reference signs. In the drawing:

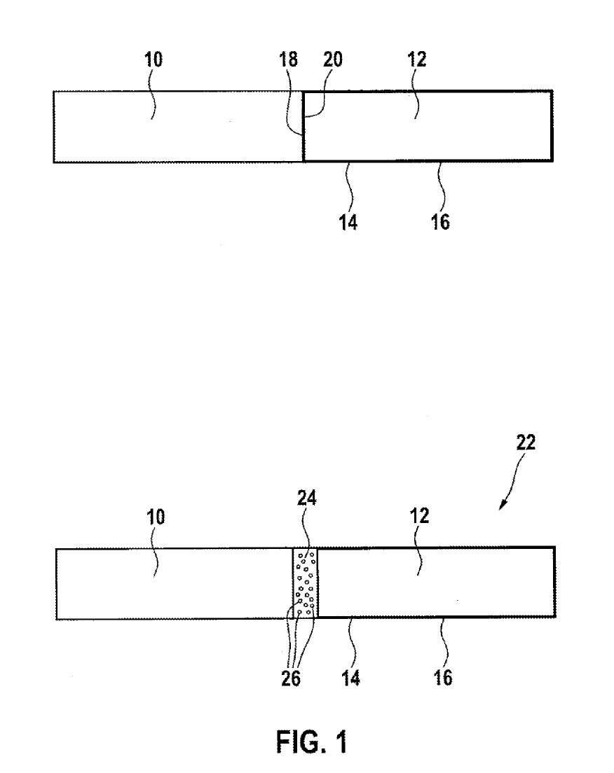

FIG. 1 shows a schematic illustration of two components before and after the welding process, as is known from the prior art;

FIG. 2 shows two components before and after the welding process upon use of the method according to the invention;

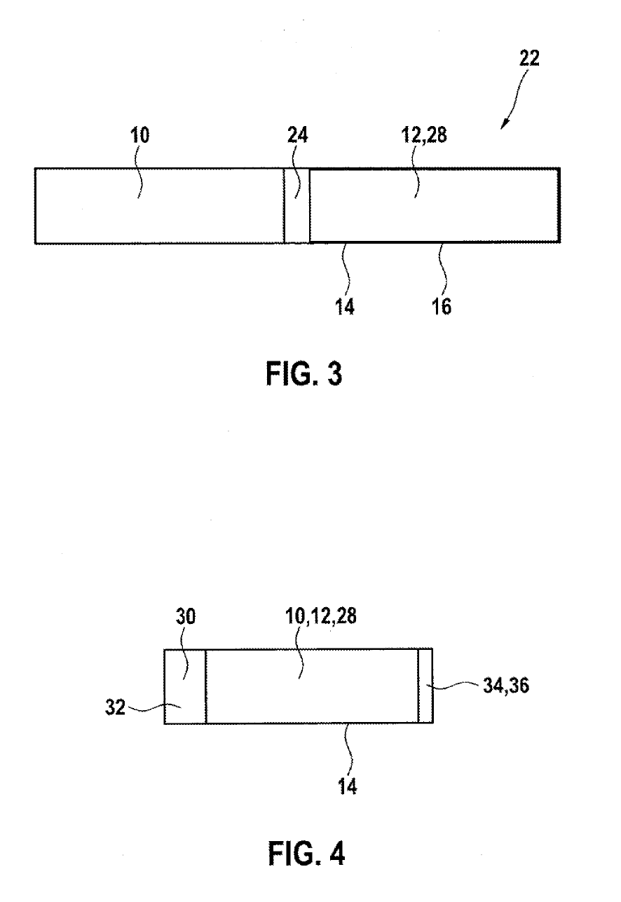

FIG. 3 shows two components after the welding process upon use of a method according to the invention; and

FIG. 4 shows a component according to the invention upon use of the method according to the invention; and

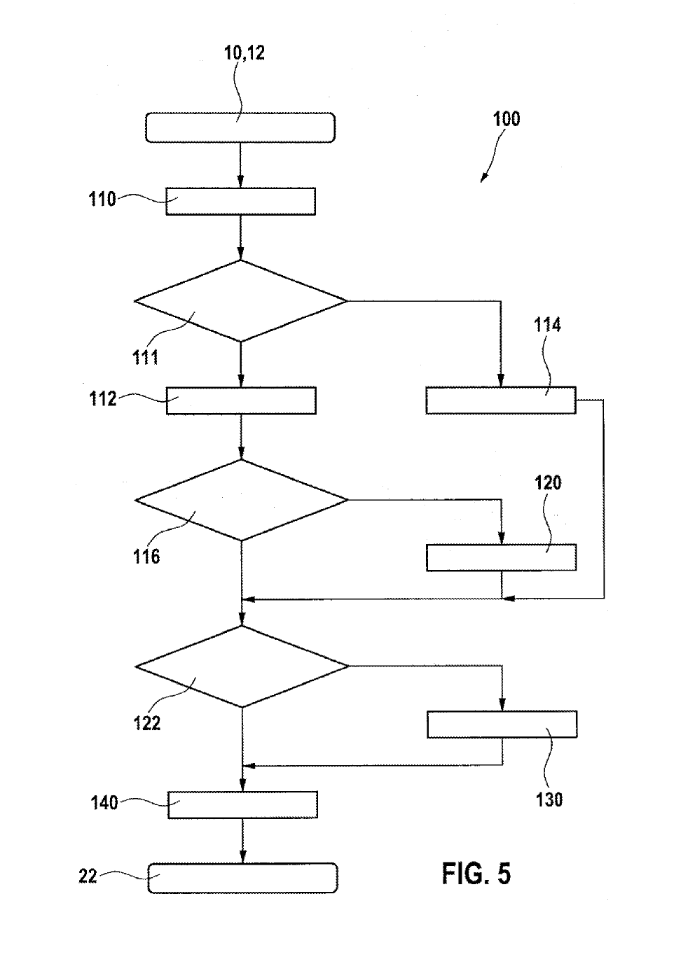

FIG. 5 shows a flow chart of the method according to the invention.

At the top, FIG. 1 shows two components 10, 12 before welding. The component 10 on the left can in this case be a component which has been produced by the metal injection molding process. It is also conceivable, however, for this component 10 to have been produced by means of conventional production processes, that is to say common steel production with subsequent shaping in the form of injection molding and/or turning and/or milling. The component 12 on the right has a nitriding layer 16 on its component surface 14. The two components 10, 12 touch one another at one of their short narrow sides 18, 20. The nitriding layer 16 is a surface layer which has been produced by nitriding. Nitriding is a process for hardening the surface of steel. Various processes are conceivable here, for example bath nitriding, gas nitriding or plasma nitriding. Nitrogen is bound in the nitriding layer 16.

At the bottom, FIG. 1 shows the two components 10, 12 after the use of a welding method as is currently known from the prior art. The two components 10, 12 are welded here to form a welded part 22. The components 10, 12 are connected via the weld seam 24 at the contact face of the two short narrow sides 18, 20 shown at the top in FIG. 1. This weld seam 24 has a multiplicity of pores 26. During the welding process, the nitrogen bound in the nitriding layer is dissolved by the melting of the nitriding layer or of the material having a high nitrogen content. This leads to what is known as outgassing of the nitrogen. This leads to an extensive formation of pores in the weld seam 24, as a result of which the cross section of the latter is weakened.

FIG. 2 shows two illustrations of components as are connected to one another upon use of a welding method according to the invention. At the top, FIG. 2 shows components 10, 12, with component 12 having a nitriding layer 16 on the component surface 14. The component 10, which has been produced for example by a powder metallurgy process, such as metal injection molding, has a titanium content which is sufficient for bonding the nitrogen outgassing during the welding method. This titanium content can lie for example between 0.5 and 1.5% by weight. This component is therefore referred to as a titanium-containing component 28 hereinbelow. The two components 28, 12 touch one another at their two short narrow sides 18, 20.

At the bottom, FIG. 2 then shows a finished welded part 22, as is produced upon use of a welding method according to the invention. The two components 28, 12 are connected to one another by a weld seam 24. In contrast to the weld seam 24 shown in FIG. 1, this weld seam 24 does not have any pores 26. In the method according to the invention, the two components are fused at their joint on the two short narrow sides 18, 20 during welding. Here, too, the nitrogen dissolved in the nitriding layer 16 of the component 12 is outgassed. However, this nitrogen is bound immediately by the titanium dissolved in the titanium-containing component 28 in the region of the entire weld seam, i.e. in particular also in deeper positions of the component 22, and bonds therewith to form titanium nitride. As a result, the formation of pores (as in FIG. 1) can be avoided. Consequently, the cross section of the weld seam 24 is not weakened. The strength of the weld seam 24 can therefore be increased considerably compared to the prior art as shown in FIG. 1.

FIG. 3 shows a welded part 22 consisting of a first component 10 and a titanium-containing component 12, 28. In contrast to FIG. 2, however, the titanium-containing component 28 has a nitriding layer 16 in its component surface 14. It is thus possible, for example, to produce titanium-containing components 28 in the course of conventional steel production or in the course of the component production by metal injection molding and to coat these with a nitriding layer 16 in the subsequent process step. This titanium-containing component 28 provided with a nitriding layer 16 can then be welded to a conventional steel component 10. In this case, too, the nitrogen outgassing from the nitriding layer 16 is bound by the titanium present in the titanium-containing component to form titanium nitride, as a result of which the formation of pores in the weld seam 24 is avoided. As is also the case in FIG. 2, the weld seam 24 in FIG. 3 is consequently not weakened by pores 26 formed by nitrogen.

FIG. 4 shows a component 10, 12, 28 according to the invention as can be present in the method according to the invention before being welded to a further component 10, 12. At least at its component surface 30 on the left, the component 10, 12, 28 has a region 32 with a titanium content of approximately 1.5% by weight. This region 32 can reach, for example, down to a depth of 20 mm, proceeding from the component surface 14. At its component surface 34 on the right, the component has a region 36 with a titanium content of approximately 0.5% by weight. This region can reach, for example, down to a depth of 12 mm, proceeding from the component surface 14. Consequently, depending on the geometry of the component to be welded to the component 10, 12, 28, it is possible for the titanium content to be added to the component in each case in a manner adapted to the respective requirements.

FIG. 5 shows a flow chart of a method according to the invention. At the start of the welding method 100, at least two components 10, 12 which are not connected to one another are present. Titanium is then added to at least one of these components in a method step 110. It is then possible to decide 111 whether or not titanium is to be applied to the surface of the component. In this respect, the titanium can either be admixed in a method step 112 or can be applied to the joint of the two components in a method step 114. If the titanium is admixed in method step 112 and is not applied to the component surface 14, it is introduced into the component already during the production process for at least one of the components. On the one hand, for conventional steel production, this can take place in the form of a titanium alloy by the addition of a quantity of titanium which is optimized for the application. On the other hand, it is possible to employ the powder injection molding process MIM for the production of the components. In this case, it is possible to admix any desired titanium content into the starting metal powder, in which case it is then possible to set a titanium content optimized for the application. In process step 114, titanium is applied to the weld joint of the components. This can be done by melting titanium onto the weld joint. It is also possible to apply a titanium-containing material to the weld joint in the form of a readily fusible titanium alloy. Alternatively, it is also conceivable to introduce individual titanium atoms into the surface of the components by sputtering. In the next step 116, it is then possible to decide whether titanium is to be applied to the surface of the component to which titanium has already been admixed in step 112. The application of the titanium to the component surface is performed in process step 120 in a manner analogous to process step 114, but following process step 112, such that not only is titanium admixed during the component production, but also titanium is applied to the component surface or to the weld joint of the components. Following process step 114, or process step 120, the decision 122 can be made as to whether a nitriding process is to take place. In such a nitriding process 130, one of the two components to be welded or else both components can be provided with a nitriding layer. In this respect, it is also possible to provide the component to which titanium has been admixed in process step 112 with a nitriding layer. If no nitriding process is to be carried out, or following the nitriding process 130, the welding process 140 is performed. The welding is in this respect performed in a manner analogous to FIGS. 2 and 3. The nitrogen outgassing from the components upon melting during the welding process 140 is bound immediately by the titanium bound in the components to form titanium nitride. A welded part 22, as is shown by way of example in FIGS. 2 and 3, is formed at the end of the welding process 140. In this welded part 22, two components 10, 12, 28 are connected to one another via a pore-free weld seam 24.

1. A method for joining metal components by welding, comprising:
adding titanium to at least one of a first component and a second component, wherein at least one of the first component and second component is a nitrogen-containing component; and
welding the first component to the second component.

2. The method as claimed in claim 1, wherein titanium is admixed to at least one of the first component and second component before the welding.

3. The method as claimed in claim 1, wherein titanium is applied to a weld joint of the at least one of the first component and second component before the welding step.

4. The method as claimed in claim 1, wherein titanium is added to at least one of the first component and second component in a form of at least one of pure titanium, titanium-containing compounds, and of titanium-containing alloys.

5. The method as claimed in claim 1, wherein at least one of the first component and second component is formed via a powder metallurgy production process.

6. The method as claimed in claim 1, further comprising subjecting at least one of the first component and second component to a nitriding process before the welding step.

7. The method as claimed in claim 1, wherein, after adding the titanium, at least one of the first component and second component has, at least in certain regions, a titanium content in a range of approximately 0.2% by weight to approximately 10% by weight.

8. The method as claimed in claim 1, wherein titanium is added to at least one of the first component and second component before the welding step such that, proceeding from a surface of the at least one of the first component and second component, a titanium content of approximately 0.2% by weight to approximately 5% by weight is formed in a depth range of approximately 0 mm to approximately 20 mm.

9. The method as claimed in claim 1, wherein the at least one of the first component and second component that is the nitrogen-containing component is at least one of a nitrogen-alloyed component and a nitrided component.

10. The method as claimed in claim 1, wherein nitrogen outgassing during the welding is bound at least partially in a form of titanium nitride.

11. A steel component for joining with another metal component, comprising, at least in certain regions, a titanium content in a range of approximately 0.2% by weight to approximately 10% by weight.

12. The steel component as claimed in claim 11, wherein the titanium content is in a range of approximately 0.2% by weight to approximately 5% by weight, and is in a depth range of approximately 0 mm to approximately 20 mm from a surface of the component.

13. The steel component as claimed in claim 11, wherein the titanium content is distributed homogeneously throughout a volume of the component.
